(19) United States
(12) Patent Application Publication
(10) Pub. No.: US 2010/0254808 A1
(43) Pub. Date: Oct. 7, 2010

(54) MULTI-DIRECTIONAL WIND GUIDE APPARATUS FOR VERTICAL SHAFT MINDMILL

(76) Inventors: Hong Su Kim, Ulsan (KR); Gi Cher Kim, Ulsan (KR)

Correspondence Address: CHRISTOPHER PAUL MITCHELL, 888 16TH ST., NW, SUITE 800, WASHINGTON, DC, 20006, US

(21) Appl. No.: 12/743,366

(22) PCT Filed: Jul. 17, 2009
(86) PCT No.: PCT/KR09/03987

§ 371 Date: May 17, 2010

(30) Foreign Application Priority Data
Jul. 25, 2008 (KR) 10-2008-0072521
Jul. 25, 2008 (KR) 10-2008-0072528

(51) Int. Cl. F03D 1/04; F01D 5/14

(52) U.S. Cl. 415/208.1; 416/231 R

(57) ABSTRACT

The present invention relates to a vertical shaft aero-generator. An aero-generator has the advantage that it is not influenced by the wind direction, but the resistance in the reverse direction of rotation is a disadvantage thereof. For figuring out this disadvantage, a plurality of dimple panel wind guide apparatuses are mounted around the outer surface of a cylindrical vertical shaft windmill as well as on top and bottom thereof in order to maximally guide the wind coming from various directions including above and below to the rotational direction of the windmill, thereby the efficiency of the vertical shaft aero-generator is increased. The dimple panel wind guide apparatus includes a feature that a great number of dimples are formed on both entire lateral surfaces of the dimple panel so that the resistance may be minimized.

### TECHNICAL FIELD

The present invention relates to a vertical shaft wind-powered generator, and in particular to a wind guide panel which blocks the wind that blows in reverse rotational direction and guide the wind in such a way as to blow in the rotational direction, and which also functions as an outer frame of a cylindrical windmill to improve the efficiency of a vertical shaft windmill.

### BACKGROUND ART

Windmill of a vertical shaft wind-powered generator has the advantage being not influenced by wind directions, but has the disadvantage that the resistance in reverse rotational direction reduces the efficiency.

To improve the above disadvantage, plural wind guide panels are mounted external to a vertical shaft windmill, wherein the wind guide panels function to block the wind that blows in reverse rotational direction and to guide the wind in such a way as to blow in the rotational direction.

### DISCLOSURE

### [Technical Problem]

<References>

1. Registration No./date: 04047834 (Sep. 13, 1977)

2. Registration No./date: 04142822 (Mar. 6, 1979)

3. Registration No./date: 06740989 (May 25, 2004)

References 1, 2 and 3 all disclose the applying of the wind guide panels for guiding the wind of the vertical shaft windmill in such a manner that the wind in reverse rotational direction blows in the rotational direction, but those references failed to disclose the present invention.

The wind guide panel according to the present invention functions to block the wind that blows in reverse rotational direction and to change the wind direction in such a way as to blow in a rotational direction, and further the panel serves to minimize the resistance in the course of the change in the wind direction performed by the wind guide panel.

The reduction of resistance is needed to change the wind direction without interfering with the wind velocity as much as possible, which is very important in improving the efficiency. The conventional wind guide panels disclosed in the above cited references 1, 2, and 3 failed to disclose the solutions.

### [Technical Solution]

The present invention discloses multi-directional wind guide apparatus provided with vertical lateral wind guide apparatus, top and bottom wind guide apparatus, and dimple panels for minimizing the resistance.

The present invention is characterized in that numerous dimples are formed on both entire lateral surfaces of the wind guide panel, which constitutes the dimple panel, and the plural dimple panel wind guide apparatus are vertically mounted on an outer periphery of the cylindrical vertical shaft windmill in which the top and bottom wind guide apparatus are mounted, such that the wind blowing in all directions, such as in reverse direction, in downward direction, in upward direction, or in various diagonal directions, etc., can be maximally guided in a rotational direction. Further, the present invention provides the dimple panel wind guide apparatus enabling to improve the wind flow by minimizing the resistance.

### DESCRIPTION OF DRAWINGS

FIG. 1 is a perspective view of the entire assembly of the present invention.

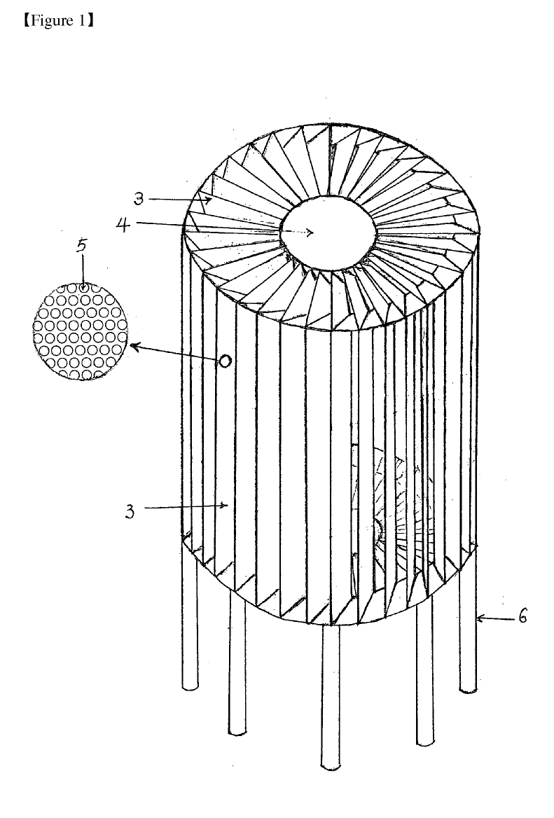

FIG. 2 is a side view of lateral wind guide apparatus according to the present invention.

FIG. 3 is a plan view of top wind guide apparatus according to the invention.

FIG. 4 is a bottom view of bottom wind guide apparatus according to the present invention.

FIG. 5 is a plan view of a windmill according to the present invention.

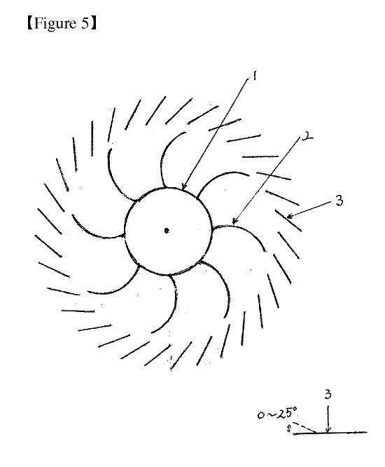

FIG. 6 is a wind guide apparatus shown in reference 1 (Sep. 13, 1977)

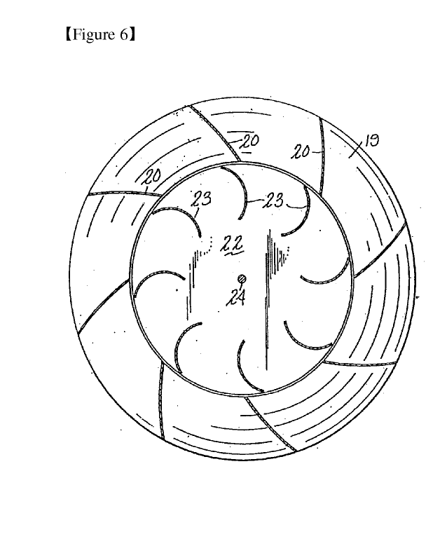

FIG. 7 is a wind guide apparatus shown in reference 2 (Mar. 6, 1979)

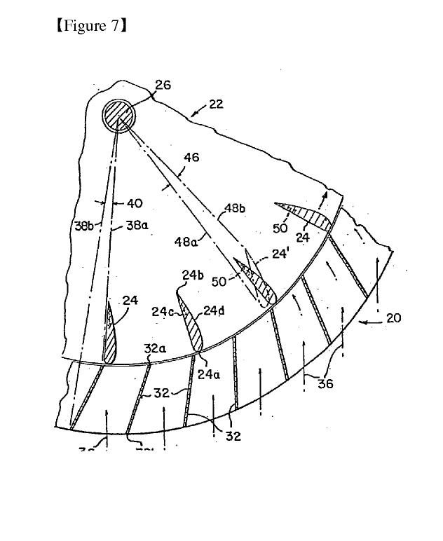

FIG. 8 is a wind guide apparatus shown in reference 3 (May 25, 2004).

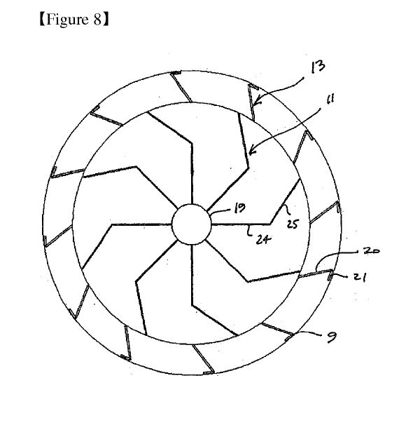

### REFERENCE NUMERALS IN THE ACCOMPANYING DRAWINGS

1. windmill

2. blade

3. wind guide panel

4. room for electricity generation and machines

5. dimple

6. post

### BEST MODE

The present invention provides a wind guide apparatus consisting of wind guide panels each having both sides thereof, in which the entire surface of each of the sides is provided with numerous dimples 5, such that the wind resistance is minimized to thereby improve the efficiency.

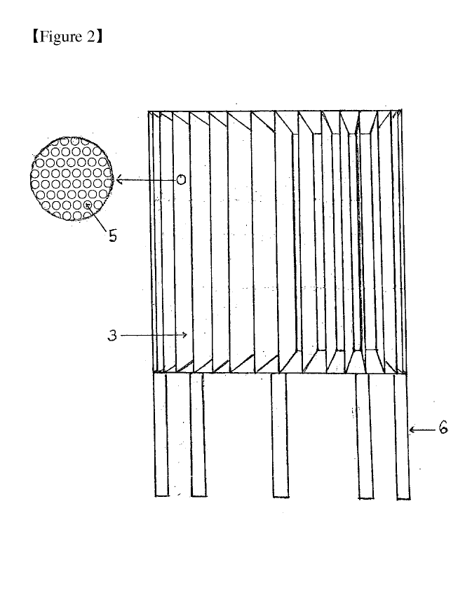

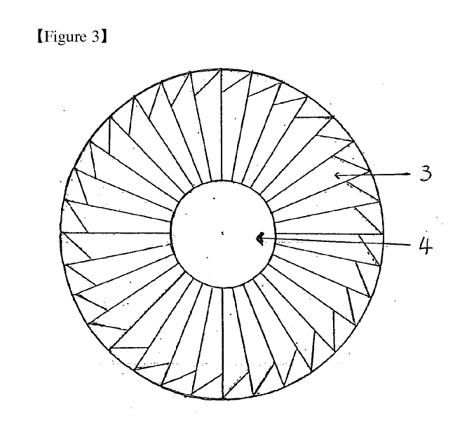

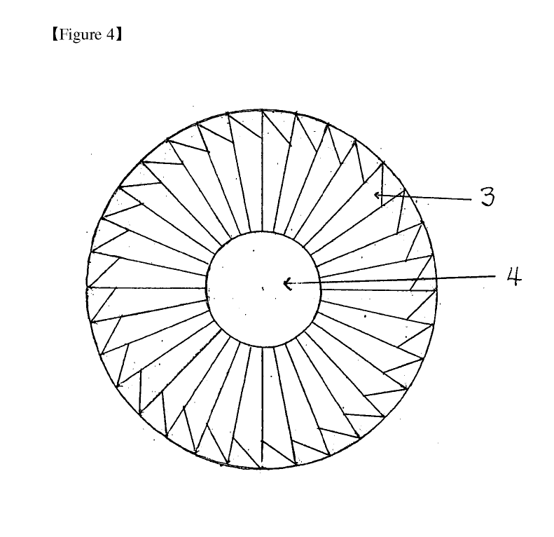

The present invention is further characterized in that lateral wind guide apparatus vertically mounted (see FIG. 2), top wind guide apparatus (see FIG. 3), and bottom wind guide apparatus (see FIG. 4) are installed, such that multi-directional wind guide apparatus can be obtained which enables to maximally exploit the winds which blow in all directions, such as the wind blowing in downward direction, the wind blowing in upward direction, the wind blowing in diagonal direction for each of the wind directions, etc.

The present invention is further characterized in that the wind guide apparatus mounted external to the vertical shaft windmill also functions as an external frame of the windmill.

Further, the present invention is also characterized in that a portion of the width of the wind guide panel is vertically bended within the range of approximately between 0 to 25-degrees, so as to improve the functional strength of the frame.

Further, the present invention is also characterized in that the inventive apparatus has a cylindrical drum at a center of the top and bottom wind guide panels, which is used as a room 4 for containing electricity generation and machines.

1. Multi-directional wind guide apparatus, characterized in that the present invention comprises dimple panels, each panel having both sides thereof and the entire surface of each of the sides being provided with numerous dimples 5, and in that the plural dimple panels are mounted, as wind guide apparatus, around an outer periphery of a cylindrical vertical shaft windmill, wherein the mounting of said wind guide apparatus, top wind guide apparatus and bottom wind guide apparatus functions as a frame of the windmill, and wherein the above wind guide apparatus allow all winds that blow in various directions to be maximally exploited in such a way as to blow in a rotational direction.

2. Multi-directional wind guide apparatus according to claim 1, characterized in that the number of wind guide panels is increased or decreased depending upon the diameter size of the vertical shaft windmill.

3. Multi-directional wind guide apparatus according to claim 1, characterized in that the plural wind guide apparatus mounted on the outer periphery of the vertical shaft windmill, wing guide apparatus mounted on the top and bottom wind guide apparatus, function as the frame of the vertical shaft windmill.

4. Multi-directional wind guide apparatus according to claim 1, characterized in that the dimple panel wind guide apparatus has both sides thereof, wherein the entire surface of each side is provided with numerous dimples 5.

5. Multi-directional wind guide apparatus according to claim 1, characterized in that the dimple panel wind guide apparatus is mounted on the outer peripheral lateral surface of the vertical shaft windmill.

6. Multi-directional wind guide apparatus according to claim 1, characterized in that the top wind guide apparatus is mounted on the top of the vertical shaft windmill.

7. Multi-directional wind guide apparatus according to claim 1, characterized in that the bottom wind guide apparatus is mounted on the bottom of the vertical shaft windmill.

8. Multi-directional wind guide apparatus according to claim 3, characterized in that a portion of the width of the wind guide panel is vertically bended within the range of approximately between 0 to 25-degrees.
